(19) United States
(12) Patent Application Publication
(10) Pub. No.: US 2010/0042710 A1
(43) Pub. Date: Feb. 18, 2010

(54) REMOTE MANAGEMENT OF COMPUTER SYSTEM

(75) Inventor: Chih-Lung Lin, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/539,716

(22) Filed: Aug. 12, 2009

(30) Foreign Application Priority Data
Aug. 15, 2008 (TW) 097131311

(51) Int. Cl. G06F 15/177

(52) U.S. Cl. 709/222; 713/2

(57) ABSTRACT

A computer system is remotely managed by a console. The computer system includes a central processing unit, a chipset, a network chip, an embedded controller and a basic input output system. The chipset communicates with the central processing unit. The network chip communicates with the chipset. The embedded controller communicates with the network chip and the chipset. The basic input output system communicates with the chipset. The embedded controller is connected to the Internet through the network chip to acquire a fixed IP address or a dynamic address, thereby exchanging data with the console through the Internet.

### FIELD OF THE INVENTION

The present invention relates to the remote management of a computer system, and more particularly to the remote management of a computer system for performing debugging and managing processes via a console.

### BACKGROUND OF THE INVENTION

Recently, an Intel Active Management Technology (iMAT) is proposed by Intel Corporation in order for allowing the information technology (IT) sector to efficiently manage personal computer. The iMAT is a remote management technology having certain functionalities to make the personal computers easier and less expensive for the IT sector to be monitored, maintained or managed. If a personal computer fails to normally operate, checking and debugging processes associated with the hardware components of the personal computer are implemented by a remote management console through Internet connection.

For utilizing the iMAT remote management technology, the manufacturer of the motherboard needs to purchase the exclusive iMAT chips that are provided by Intel Corporation. For example, the manufacturer of the motherboard needs to purchase the central processing unit, the north bridge chip, the south bridge chip and the network chip that are provided by Intel Corporation in order to achieve the iMAT remote management purpose. In other words, the central processing unit, the north bridge chip, the south bridge chip and the network chip provided by other chip manufacturers fail to be applied to the motherboard.

### SUMMARY OF THE INVENTION

In accordance with an aspect of the present invention, there is provided a computer system to be remotely managed by a console. The computer system includes a central processing unit, a chipset, a network chip, an embedded controller and a basic input output system. The chipset communicates with the central processing unit. The network chip communicates with the chipset. The embedded controller communicates with the network chip and the chipset. The basic input output system communicates with the chipset. The embedded controller is connected to the Internet through the network chip to acquire a fixed IP address or a dynamic address, thereby exchanging data with the console through the Internet.

In accordance with another aspect of the present invention, there is provided a computer system to be remotely managed by a console. The computer system includes a central processing unit, a chipset, a basic input output system, a first network chip, a second network chip, an embedded controller and a switching unit. The chipset communicates with the central processing unit. The basic input output system communicates with the chipset. The first network chip communicates with the chipset. The embedded controller communicates with the second network chip and the chipset. The switching unit is controlled by the embedded controller, thereby selecting connecting the first network chip or the second network chip with an Internet. The embedded controller is connected to the Internet through the first network chip or the second network chip to acquire a fixed IP address or a dynamic address, thereby exchanging data with the console through the Internet.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a remote management computer system according to a first embodiment of the present invention;

FIG. 2A is a flowchart schematically illustrating a process of initializing the BIOS during the computer system is booted;

FIG. 2B is a flowchart schematically illustrating the operations of the embedded controller when the BIOS initialization process is performed; and

FIG. 3 is a schematic functional block diagram illustrating the remote management of a computer system according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

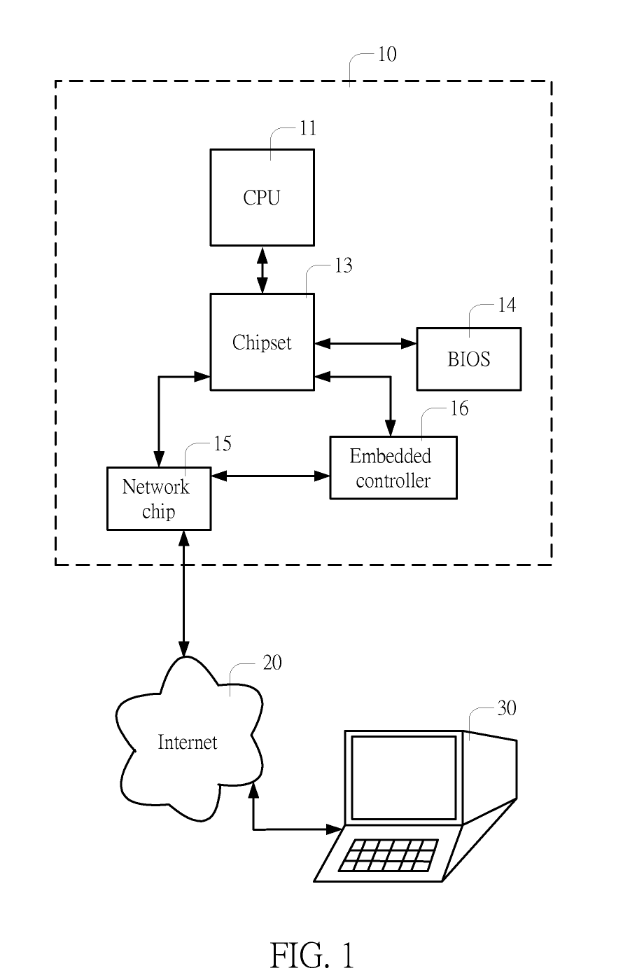

FIG. 1 is a schematic functional block diagram illustrating the remote management of a computer system according to a first embodiment of the present invention. As shown in FIG. 1, the computer system 10 comprises a central processing unit (CPU) 11, a chipset 13, a network chip 15, an embedded controller 16 and a basic input output system (BIOS) 14. The chipset 13 is connected with the CPU 11, the network chip 15, the BIOS 14 and the embedded controller 16. Via connection of the Internet 20, the network chip 15 is connected with a console 30. The embedded controller 16 is a built-in component of the current computer host. An example of the chipset 13 includes but is not limited to a south bridge chip or a combination of a south bridge chip and a north bridge chip.

The embedded controller 16 that is connected with the chipset 13 is responsible for the power management of the computer system 10. That is, the embedded controller 16 is continuously powered on. The general power management specification defines several states. For example, S0 is the normal working state of the computer system 10, meaning that all components of the operating system normally run. At the S3 state, the CPU 11 is powered off, but other components are still powered on. At the S4 state, the main circuitry (e.g. the CPU 11 and the chipset 13) and other components are powered off, but some specified devices (e.g. the embedded controller 16 and the network chip 15) are still powered on. At the S5 state, the main circuitry (e.g. the CPU 11 and the chipset 13) and other components are powered off, but some specified devices are still powered on.

In addition to the power management of the computer system 10, the embedded controller 16 could issue the information of the computer system 10 to the console 30 through the Internet 20. As such, the user can monitor the operating statuses of the computer system 10 by the console 30. In a case that the computer system 10 has a breakdown, the embedded controller 16 could be controlled by the console 30 in order to perform the debugging process.

In some embodiments, the embedded controller 16 can acquire a fixed IP address from the Internet 20. For example, when the fixed IP address is inputted into the computer system 10 via the BIOS settings, the embedded controller 16 acquires the fixed IP address. In some embodiments, if the Internet 20 is connected to a dynamic host configuration protocol (DHCP) server, the embedded controller 16 can acquire a dynamic IP address from the Internet 20.

The network chip 15 is controlled by the chipset 13 or the embedded controller 16. The network chip 15 could discriminate whether the data packet is transmitted from the chipset 13 or the embedded controller 16.

The functions of the remote management of the computer system according to the first embodiment of the present invention will be illustrated in more details as follows.

### (1) Remotely Power-On, Power-Off or Reset the Computer System:

Via the Internet 20, the console 30 could issue a data packet including a power-on, power-off or remote resetting command to the embedded controller 16. After the data packet is decoded by the embedded controller 16, the computer system 10 is booted, powered off or reset according to the power-on, power-off or remote resetting command. In some embodiments, the data packet further comprises a boot device command. According to the boot device command, the BIOS 14 controls the boot device such as the storage medium of the computer system 10, the network device or the console 30 to boot the computer system 10 during the initialization. The storage medium of the computer system 10 includes the local hard disc drive, the local optical drive and the flash storage device. In a case that the boot device command involves in the console 30, the computer system 10 is booted according to the operating system designated by the console 30.

### (2) Remotely Access Information and Log Files of the Computer System:

During the computer system 10 is booted and the BIOS 14 is initialized, log files are continuously transmitted to the embedded controller 16 and stored in a storage unit (e.g. a flash memory) of the embedded controller 16. At the same time, the log files are transmitted from the embedded controller 16 to the console 30 through the Internet 20. According to the log files, the console 30 can realize the initializing results of the computer system 10. In some embodiments, the system information can be transmitted from the embedded controller 16 to the console 30 through the Internet 20 as long as the embedded controller 16 is powered on.

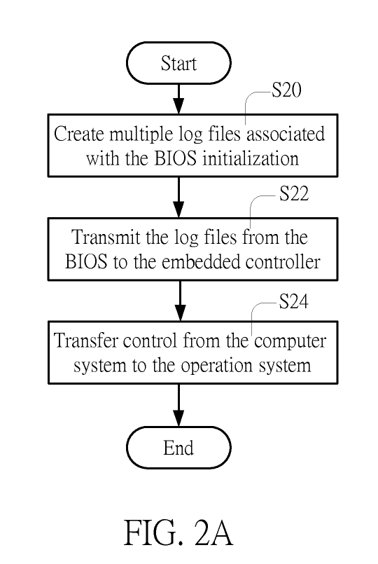

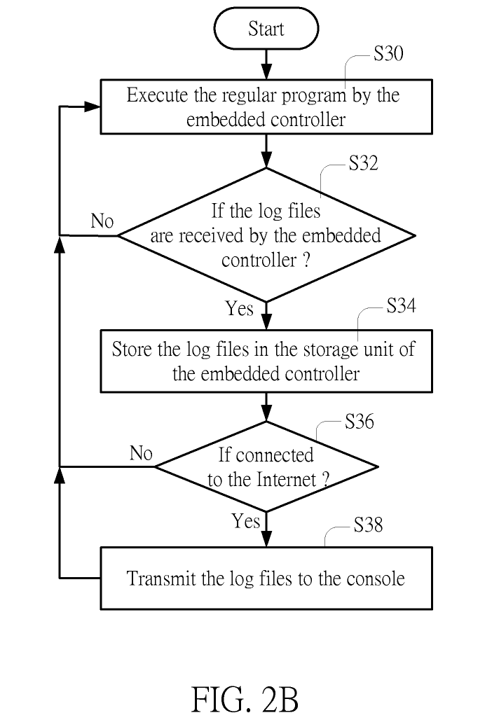

FIG. 2A is a flowchart schematically illustrating a process of initializing the BIOS during the computer system is booted. First of all, multiple log files associated with the BIOS initialization are created (Step S20). Then, these log files are transmitted from the BIOS to the embedded controller (Step S22). After the BIOS initialization is completed, the computer system transfers control to the operating system (Step S24).

FIG. 2B is a flowchart schematically illustrating the operations of the embedded controller when the BIOS initialization process is performed. First of all, the embedded controller executes the regular program such as a power management program (Step S30). Then, the embedded controller will wait for the log files that are transmitted from the BIOS in an event-triggering fashion. If the log files are received by the embedded controller (Step S32), the log files will be stored in the storage unit of the embedded controller (Step S34). Otherwise, if no log files are received by the embedded controller (Step S32), the embedded controller continuously executes the regular program (Step S30).

After the log files are stored in the storage unit of the embedded controller (Step S34), the embedded controller will discriminate whether the computer system is connected to the Internet (Step S36). If the computer system is connected to the Internet, the log files will be transmitted from the embedded controller to the console (Step S38). Otherwise, if the computer system has not been connected to the Internet, the embedded controller continuously executes the regular program (Step S30).

For example, during the computer system 10 is booted and the BIOS 14 is initialized, the hardware conditions of the computer system 10 will be successively checked. The log files associated with the hardware conditions of the computer system 10 (e.g. normal CPU, normal chipset, normal VGA and normal network chip conditions) are stored into the storage unit of the embedded controller 16. Then, the log files will be transmitted from the embedded controller 16 to the console 30 through the Internet 20. At this moment, the console 30 can realize the problems occurred during the process of initializing the BIOS 14. After the BIOS initialization is completed and the operating system is loaded to finish the booting process, the embedded controller 16 can acquire the whole system information and transmit the system information to the console 30. An example of the system information includes but is not limited to the capacity of the memory, the capacity of the hard disk, the number of the VGA chip or the operating system version.

### (3) Remotely Change BIOS Settings:

For changing the settings of the BIOS 14 by the console 30, an inquiry packet is transmitted from the console 30 to the embedded controller 16 to inquire the computer system 10 about the power management state. In a case that the computer system 10 is at the S4 or S5 state, the embedded controller 16 is commanded to boot the computer system 10. Whereas, in a case that the computer system 10 is at the S0 or S3 state, the embedded controller 16 is commanded to reset the computer system 10.

During the BIOS 14 is initialized, the image shown on the monitor of the computer system 10 could be transmitted from the BIOS 14 to the console 30 through the embedded controller 16 and thus the image is shown on the monitor of the console 30. Similarly, the keyboard signal generated by the keyboard of the console 30 could be transmitted to the computer system 10. Moreover, during the BIOS 14 is initialized, the BIOS 14 can realize the command type by inquiring the embedded controller 16. Afterwards, the setup menu of the BIOS settings is created, so that the settings of the BIOS 14 could be remotely changed by the console 30. After the settings of the BIOS 14 are successfully changed, the process of initializing the BIOS 14 is performed again according to the updated settings.

### (4) Remotely Diagnose the Computer System:

For remotely diagnosing the computer system 10 by the console 30, an inquiry packet is transmitted from the console 30 to the embedded controller 16 to inquire the computer system 10 about the power management state. In a case that the computer system 10 is at the S4 or S5 state, the embedded controller 16 is commanded to boot the computer system 10. Whereas, in a case that the computer system 10 is at the S0 or S3 state, the embedded controller 16 is commanded to reset the computer system 10.

After the BIOS 14 has been successfully initialized and the operating system is loaded by the boot device that is simulated by the embedded controller 16, all requests of the computer system 10 are transmitted from the embedded controller 16 to the console 30 through the network chip 15. According to the requests, the console 30 offers corresponding response signals to the embedded controller 16. As a consequence, the operating system (e.g. a DOS operating system) provided by the console 30 will be successfully loaded into the computer system 10 so as to finish the booting process.

After the operating system provided by the console 30 has been successfully loaded into the computer system 10, the console 30 will execute a diagnostic utility program to remotely diagnose the computer system 10.

### (5) Remotely Diagnose the Computer System Through a User-Initiated Control Approach:

The user of the computer system 10 may change the settings of the BIOS 14 in order to create a first event during the BIOS 14 is initialized. In addition, the first event could be transmitted from the BIOS 14 to the console 30 through the embedded controller 16, so that the computer system 10 could be remotely diagnosed by the console 30 according to the above procedure (4). Alternatively, a triggering button is arranged on the casing of the computer system 10 and connected to the embedded controller 16. When the triggering button is depressed, the triggering button generates the same first event. Similarly, the first event is transmitted to the console 30, so that the computer system 10 could be remotely diagnosed by the console 30 according to the above procedure (4).

### (6) Remote Recovery Task:

For setting the BIOS 14 by the console 30, an inquiry packet is transmitted from the console 30 to the embedded controller 16 to inquire the computer system 10 about the power management state. In a case that the computer system 10 is at the S4 or S5 state, the embedded controller 16 is commanded to boot the computer system 10. Whereas, in a case that the computer system 10 is at the S0 or S3 state, the embedded controller 16 is commanded to reset the computer system 10.

During the BIOS 14 is initialized, the image shown on the monitor of the computer system 10 could be transmitted from the BIOS 14 to the console 30 through the embedded controller 16 and thus the image is shown on the monitor of the console 30. Similarly, the keyboard signal generated by the keyboard of the console 30 could be transmitted to the computer system 10.

After the BIOS 14 has been successfully initialized and the operating system is loaded by the boot device that is simulated by the embedded controller 16, all requests of the computer system 10 are transmitted from the embedded controller 16 to the console 30 through the network chip 15. According to the requests, the console 30 offers corresponding response signals to the embedded controller 16. As a consequence, the operating system (e.g. a DOS operating system) provided by the console 30 will be successfully loaded into the computer system 10 so as to finish the booting process.

After the operating system provided by the console 30 has been successfully loaded into the computer system 10, the console 30 will execute a recovery program to remotely recover the lost, deleted and corrupt data from the storage device of the computer system 10. Moreover, the recovery program could provide a menu option. Via the menu option, the operator of the console 30 can select a source image file in order to implement the remote recovery task. In addition, the recovery program and the source image file could be provided by the simulated boot device through the console 30 or by other storage device of the computer system 10.

In some embodiments, during the BIOS 14 is initialized, the command type is realized according to a specified packet transmitted from the console 30. The source image file is retrieved from the storage device that is controlled by the console 30 according to the command, thereby implementing the remote recovery task.

### (7) Remote Recovery Task Through a User-Initiated Control Approach:

The user of the computer system 10 may change the settings of the BIOS 14 in order to create a second event during the BIOS 14 is initialized. In addition, the second event could be transmitted from the BIOS 14 to the console 30 through the embedded controller 16. As such, the console 30 will remotely recover the lost, deleted and corrupt data from the storage device of the computer system 10 according to the above procedure (6). Alternatively, a triggering button is arranged on the casing of the computer system 10 and connected to the embedded controller 16. When the triggering button is depressed, the triggering button generates the same second event. Similarly, the second event is transmitted to the console 30, so that the console 30 implements the remote recovery task according to the above procedure (6).

### (8) Remote BIOS Recovery Task:

In the beginning of the initialization of the BIOS 14, a specified log file is transmitted to the embedded controller 16. After the embedded controller 16 of the computer system 10 is powered on for a certain time period but the specified log file has not been received, the embedded controller 16 will consider that the BIOS 14 fails to be successfully initialized. Meanwhile, the embedded controller 16 issues a BIOS recovery request to the console 30.

After the BIOS recovery request is received by the console 30, the console 30 issues a model inquiring command to the embedded controller 16. According to the model inquiring command, the information associated with the BIOS model is transmitted from the embedded controller 16 to the console 30. According to the BIOS model, the console 30 searches a corresponding BIOS binary file. The BIOS binary file is then transmitted to the embedded controller 16 of the computer system 10, thereby implementing the BIOS recovery task.

During the process of remotely recovering the BIOS, the embedded controller 16 could control the computer system 10 to generate a specified sound effect or a specified light prompt. According to the sound effect or the light prompt, the user of the computer system 10 can realize that the BIOS 14 of the computer system 10 is being refreshed as well as the refresh progress.

### (9) Remotely Activate a Predetermined Utility Program:

After the operating system has been successfully loaded into the computer system 10, the embedded controller 16 of the computer system 10 can exchange data with the console 30 according to a predetermined driver and a predetermined utility program. After a packet including the command for activating the predetermined utility program is transmitted from the console 30 to the embedded controller 16, the embedded controller 16 creates a third event to the predetermined driver. According to the third event, the predetermined utility program is activated. An example of the predetermined utility program is a remote desktop application program. After the remote desktop application program of the computer system 10 is activated, the desktop of the computer system 10 will be shown on the console 30. Meanwhile, the computer system 10 is remotely controlled by the console 30. For example, the anti-software of the computer system 10 is updated by the console 30.

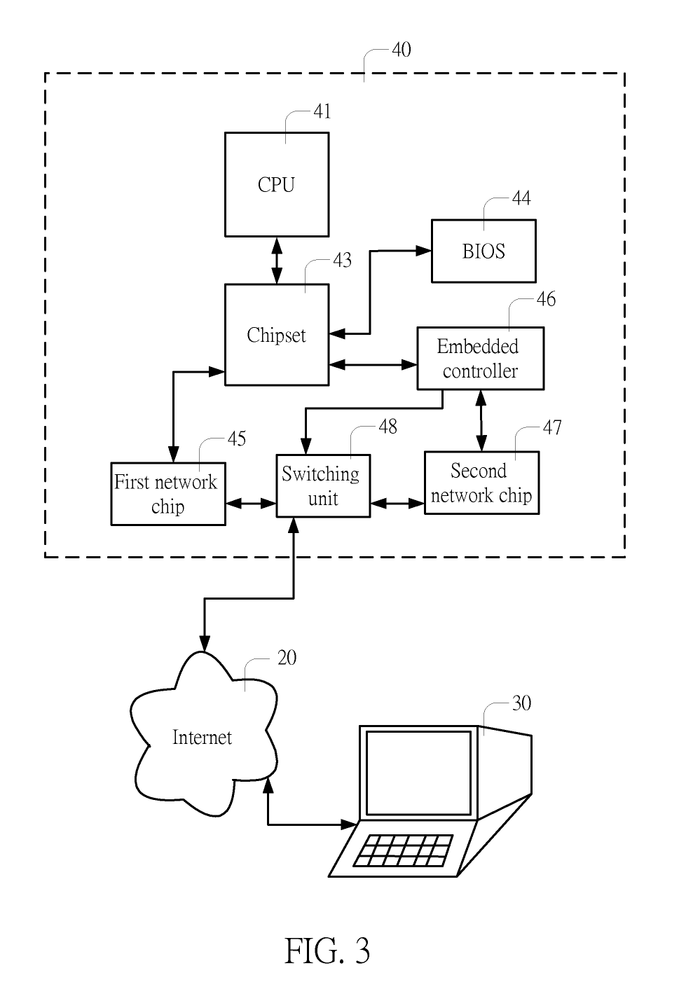

FIG. 3 is a schematic functional block diagram illustrating the remote management of a computer system according to a second embodiment of the present invention. As shown in FIG. 3, the computer system 40 comprises a central processing unit (CPU) 41, a chipset 43, a first network chip 45, a second network chip 47, a switching unit 48, an embedded controller 46 and a basic input output system (BIOS) 44. The chipset 43 is connected with the CPU 41, the first network chip 45, the BIOS 44 and the embedded controller 46. The embedded controller 46 is connected to the second network chip 47. The switching unit 48 is controlled by the embedded controller 46, thereby selectively connecting the first network chip 45 or the second network chip 47 with the Internet 20. The console 30 is also connected to the Internet 20.

In this embodiment, the switching unit 48 is controlled by the embedded controller 46. During the booting process of the computer system 40 or the process of remotely controlling the computer system 40 by the console 30, the second network chip 47 communicates with the console 30. During normal operations of the computer system 40, the switching unit 48 is controlled by the embedded controller 46 such that the first network chip 45 communicates with the console 30 through the Internet 20. After the second network chip 47 communicates with the console 30, the above remote managing functions (1)˜(9) could be performed by the console 30.

From the above description, the computer system of the present invention can be remotely managed. The control chips used in the computer system can be custom-made or designed by any chip manufacturer. Through the Internet connection, the hardware components of the computer system are checked and associated debugging process is performed by the remote console.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system to be remotely managed by a console, the computer system comprising:
a central processing unit;
a chipset communicating with the central processing unit;
a network chip communicating with the chipset;
an embedded controller communicating with the network chip and the chipset; and
a basic input output system communicating with the chipset,
wherein the embedded controller is connected to the Internet through the network chip to acquire a fixed IP address or a dynamic address, thereby exchanging data with the console through the Internet.

2. The computer system according to claim 1 wherein when the console issues a power-on, power-off or remote resetting command to the embedded controller through the Internet, the computer system is booted, powered off or reset by the embedded controller according to the power-on, power-off or remote resetting command.

3. The computer system according to claim 1 wherein when the console issues a boot device command to the embedded controller through the Internet, the computer system is booted by a local hard disc drive, a local optical drive or a flash storage device of the computer system or by the console through the Internet.

4. The computer system according to claim 1 wherein during the basic input output system is initialized, the basic input output system continuously transmits multiple log files to the embedded controller and stores the log files in a storage unit of the embedded controller, and the log files are transmitted from the embedded controller to the console through the Internet.

5. The computer system according to claim 1 wherein after an operating system is loaded into the computer system, system information is transmitted from the embedded controller to the console through the Internet.

6. The computer system according to claim 1 wherein during the basic input output system is initialized, an image shown on a monitor of the computer system is transmitted from the basic input output system to the console through the embedded controller for display, and a keyboard signal generated by a keyboard of the console is transmitted from the console to the computer system, so that the settings of the basic input output system are changed in response to the keyboard signal.

7. The computer system according to claim 1 wherein the embedded controller is simulated as a boot device by the basic input output system, and an operating system is loaded into the computer system via the console, so that the console executes a diagnostic utility program to remotely diagnose the computer system or executes a recovery program to remotely recover the data from a storage device of the computer system.

8. The computer system according to claim 7 wherein a first event is generated by the embedded controller when a triggering button is depressed, so that the diagnostic utility program is executed, or a second event is generated by the embedded controller when the triggering button is depressed, so that the recovery program is executed.

9. The computer system according to claim 1 wherein if the basic input output system fails to be successfully initialized, the embedded controller issues a basic input output system recovery request to the console, so that the console issues a basic input output system binary file to the embedded controller to implement a basic input output system recovery task.

10. The computer system according to claim 1 wherein after an operating system is loaded into the computer system, the embedded controller exchanges data with the console according to a predetermined driver and a predetermined utility program.

11. A computer system to be remotely managed by a console, the computer system comprising:
a central processing unit;
a chipset communicating with the central processing unit;
a basic input output system communicating with the chipset,
a first network chip communicating with the chipset;
a second network chip;
an embedded controller communicating with the second network chip and the chipset; and
a switching unit controlled by the embedded controller, thereby selecting connecting the first network chip or the second network chip with an Internet;
wherein the embedded controller is connected to the Internet through the first network chip or the second network chip to acquire a fixed IP address or a dynamic address, thereby exchanging data with the console through the Internet.

12. The computer system according to claim 11 wherein when the console issues a power-on, power-off or remote resetting command to the embedded controller through the Internet, the computer system is booted, powered off or reset by the embedded controller according to the power-on, power-off or remote resetting command.

13. The computer system according to claim 11 wherein when the console issues a boot device command to the embedded controller through the Internet, the computer system is booted by a local hard disc drive, a local optical drive or a flash storage device of the computer system or by the console through the Internet according to the boot device command.

14. The computer system according to claim 11 wherein during the basic input output system is initialized, the basic input output system continuously transmits multiple log files to the embedded controller and stores the log files in a storage unit of the embedded controller, and the log files are transmitted from the embedded controller to the console through the Internet.

15. The computer system according to claim 11 wherein after an operating system is loaded into the computer system, system information is transmitted from the embedded controller to the console through the Internet.

16. The computer system according to claim 11 wherein during the basic input output system is initialized, an image shown on a monitor of the computer system is transmitted from the basic input output system to the console through the embedded controller for display, and a keyboard signal generated by a keyboard of the console is transmitted from the console to the computer system, so that the settings of the basic input output system are changed in response to the keyboard signal.

17. The computer system according to claim 11 wherein the embedded controller is simulated as a boot device by the basic input output system, and an operating system is loaded into the computer system via the console, so that the console executes a diagnostic utility program to remotely diagnose the computer system or executes a recovery program to remotely recover the data from a storage device of the computer system.

18. The computer system according to claim 17 wherein a first event is generated by the embedded controller when a triggering button is depressed, so that the diagnostic utility program is executed, or a second event is generated by the embedded controller when the triggering button is depressed, so that the recovery program is executed.

19. The computer system according to claim 11 wherein if the basic input output system fails to be successfully initialized, the embedded controller issues a basic input output system recovery request to the console, so that the console issues a basic input output system binary file to the embedded controller to implement a basic input output system recovery task.

20. The computer system according to claim 11 wherein after an operating system is loaded into the computer system, the embedded controller exchanges data with the console according to a predetermined driver and a predetermined utility program.
